(19) United States
(12) Patent Application Publication
(10) Pub. No.: US 2026/0359662 A1
(43) Pub. Date: Nov. 12, 2026

(54) SYSTEMS AND METHODS FOR DATA RECONCILIATION USING ROBUST ESTIMATOR GUIDED PHYSICS INFORMED NEURAL NETWORK

(71) Applicant: TATA CONSULTANCY SERVICES LIMITED, Mumbai (IN)

(72) Inventors: CHINAPANA LOKESH REDDY, Hyderabad (IN); VISHNU SWAROOPJI MASAMPALLY, Hyderabad (IN); VENKATARAMANA RUNKANA, Pune (IN)

(73) Assignee: TATA CONSULTANCY SERVICES LIMITED, Mumbai (IN)

(21) Appl. No.: 19/670,617

(22) Filed: May 7, 2026

(30) Foreign Application Priority Data
May 9, 2025 (IN) 202521044843

(51) Int. Cl. G06N 3/0985

(52) U.S. Cl. CPC G06N 3/0985

(57) ABSTRACT

In a manufacturing and process industry, a data reconciliation technique is required which can effectively rectify errors in measurements thereby providing accurate and complete information about state of a process. The present disclosure addresses unresolved problems of conventional data reconciliation approaches that require true values for training by providing a system and method for data reconciliation using robust estimator guided physics informed neural network. Real-time, physics informed data reconciliation is integrated with adaptive system identification. The present disclosure integrates a robust estimator within a Physics Informed Neural Network (PINN) architecture. Once the PINN architecture is trained instantaneous predictions are provided allowing immediate reconciliation of incoming data. Process equations are directly embedded as penalty terms in an integrated loss function. By minimizing the integrated loss function, the PINN learns a solution that fits the data while ensuring that reconciled estimates are consistent with imposed governing laws and constraints.

### PRIORITY CLAIM

This U.S. patent application claims priority under 35 U.S.C. § 119 to: Indian Patent Application No. 202521044843, filed on May 9, 2025. The entire contents of the aforementioned application are incorporated herein by reference.

### TECHNICAL FIELD

The disclosure herein generally relates to the field of data reconciliation, and, more particularly, to systems and methods for data reconciliation using robust estimator guided physics informed neural network.

### BACKGROUND

Manufacturing industries continuously monitor processes by measuring thousands of process variables and taking corrective actions to meet ever-evolving quality standards, safety regulations and environmental mandates. To make the best possible modifications in a process, its actual state must be known. This information is achieved through monitoring. These measurements of process variables are used for various activities such as optimization, process control, equipment maintenance or scheduling, management planning and decision making to run the process in an optimal and efficient manner. Since all these activities play a crucial role in attaining a final goal, it is important that the measurements received by all these tasks are accurate and reliable. However, sensor measurements are often susceptible to noise and become corrupted by errors. These errors are classified into two types as random errors and gross errors. Random errors are small in magnitude and are inevitable due to inherent variation in any instrument operation. These errors arise from a wide variety of sources including changes in ambient conditions, power fluctuations, filtering, signal conversion and transmission, and/or the like. Magnitude and the sign of these errors change even if the process is run at identical conditions. Gross errors are larger systematic biases that arise from instrument malfunction, miscalibration, process leaks, equipment failure, wear and tear, solid deposits on sensors, and/or the like. Unlike the random errors, gross errors are non-random and have a certain magnitude and sign at any given point of time. These faulty measurements compromise data quality resulting in inefficient operations, sub-optimal process control, misguided operational decisions and potential financial losses. In worst case scenarios, large gross errors can even drive the process into an unsafe operating regime. Many times, some variables are even unmeasured due to practical and economic limitations.

Correction of the errors while providing reliable and consistent data without cost and time intensive processes is still a challenging task. Existing data reconciliation techniques are categorized as traditional data reconciliation methods, robust estimators and neural network based methods. Traditional data reconciliation methods, especially the ones based on least squares estimation, work well for measurements with only random errors. However, the traditional data reconciliation methods yield biased reconciled estimates when data contains gross errors due to their assumption of normal distribution of the errors. In the presence of the gross errors, it is difficult to determine the data distribution leading to incorrect estimations and severe deviation. The traditional data reconciliation methods often struggle with processes involving unmeasured variables and bilinear/nonlinear constraints. The unmeasured variables are often eliminated by some transformations and nonlinear constraints are linearly approximated leading to loss of precision, sometimes over-simplifying and limiting their range of applicability. While robust estimators do not assume normally distributed data which makes them insensitive to gross errors, they require iterative tuning and solving at multiple steps making them computationally intensive, especially for large scale processes. A typical manufacturing plant contains thousands of interconnected units and streams and solving a reconciliation problem for such a plant in multiple iterative steps is highly time intensive process. This complexity limits their applicability for real-time data reconciliation. Further, neural network based methods often treat the process as a black box, completely relying on the data to identify the process. They lack the ability to incorporate process physics and constraints into their formulation. This limitation can lead to reconciled data that violates physical laws or fails to capture the underlying process behavior. Some of the existing neural networks either use real or simulated values of process variables as labels in a supervised learning task which makes them impractical, since true values may not be known in real scenarios.

### SUMMARY

Embodiments of the present disclosure present technological improvements as solutions to one or more of the above-mentioned technical problems recognized by the inventors in conventional systems. estimate For example, in one embodiment, a processor implemented method is provided. The processor implemented method, comprising: receiving, via one or more hardware processors, a plurality of measurement data from a plurality of data sources pertaining to one or more manufacturing and process industries; preprocessing, via the one or more hardware processors, the plurality of measurement data using one or more preprocessing techniques to obtain a plurality of preprocessed data; generating, via the one or more hardware processors, a plurality of process constraints using (i) the plurality of preprocessed data and (ii) a mathematical model representation of one or more sub-systems in the one or more manufacturing and process industries; performing, via the one or more hardware processors, a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data; inputting, via the one or more hardware processors, the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied; evaluating, via the one or more hardware processors, a performance of the physics informed neural network architecture by optimizing the plurality of hyperparameters based on a plurality of metrics to obtain a validated physics informed neural network architecture that provides an optimal performance level; predicting, via the one or more hardware processors, a plurality of reconciled estimates and a plurality of unmeasured variables for the plurality of measurement data using the validated physics informed neural network architecture; analyzing, via the one or more hardware processors, the plurality of reconciled estimates to correct at least one of (i) one or more random errors and (ii) one or more gross errors based on a plurality of gross error tests; and correcting, via the one or more hardware processors, the at least one of (i) the one or more random errors and (ii) the one or more gross errors from the plurality of reconciled estimates to obtain a plurality of consistent reconciled measurement data.

In another aspect, a system is provided. The system comprising a memory storing instructions; one or more communication interfaces; one or more sub-systems; and one or more hardware processors coupled to the memory via the one or more communication interfaces, wherein the one or more hardware processors are configured by the instructions to: receive a plurality of measurement data from a plurality of data sources pertaining to one or more manufacturing and process industries; preprocess the plurality of measurement data using one or more preprocessing techniques to obtain a plurality of preprocessed data; generate a plurality of process constraints using (i) the plurality of preprocessed data and (ii) a mathematical model representation of one or more sub-systems in the one or more manufacturing and process industries; perform a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data; input the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied; evaluate a performance of the physics informed neural network architecture by optimizing the plurality of hyperparameters based on a plurality of metrics to obtain a validated physics informed neural network architecture that provides an optimal performance level; predict a plurality of reconciled estimates and a plurality of unmeasured variables for the plurality of measurement data using the validated physics informed neural network architecture; analyze the plurality of reconciled estimates to correct at least one of (i) one or more random errors and (ii) one or more gross errors based on a plurality of gross error tests; and correct the at least one of (i) the one or more random errors and (ii) the one or more gross errors from the plurality of reconciled estimates to obtain a plurality of consistent reconciled measurement data.

In yet another aspect, a non-transitory computer readable medium is provided. The non-transitory computer readable medium are configured by instructions for receiving a plurality of measurement data from a plurality of data sources pertaining to one or more manufacturing and process industries; preprocessing the plurality of measurement data using one or more preprocessing techniques to obtain a plurality of preprocessed data; generating a plurality of process constraints using (i) the plurality of preprocessed data and (ii) a mathematical model representation of one or more sub-systems in the one or more manufacturing and process industries; performing a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data; inputting the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied; evaluating a performance of the physics informed neural network architecture by optimizing the plurality of hyperparameters based on a plurality of metrics to obtain a validated physics informed neural network architecture that provides an optimal performance level; predicting a plurality of reconciled estimates and a plurality of unmeasured variables for the plurality of measurement data using the validated physics informed neural network architecture; analyzing the plurality of reconciled estimates to correct at least one of (i) one or more random errors and (ii) one or more gross errors based on a plurality of gross error tests; and correcting the at least one of (i) the one or more random errors and (ii) the one or more gross errors from the plurality of reconciled estimates to obtain a plurality of consistent reconciled measurement data.

In accordance with an embodiment of the present disclosure, the physics informed neural network architecture is a multilayer perceptron network comprising (i) a plurality of layers, (ii) a plurality of neurons in each of the plurality of layers, and (iii) one or more activation functions tailored to a specific process and an associated process complexity.

In accordance with an embodiment of the present disclosure, the non-dimensionalization operation is performed for (i) eliminating one or more disparities between the plurality of scaled data, (ii) ensuring that a plurality of output variables vary within a predefined range, and (iii) achieving a convergence.

In accordance with an embodiment of the present disclosure, the stopping criterion states that the physics informed neural network architecture reaches a convergence value which represents that a difference between consecutive iterations of an integrated loss function falls below a predefined tolerance limit, where the integrated loss function is formulated using a weighted sum of the reconciliation loss function and the constraint loss function.

In accordance with an embodiment of the present disclosure, the plurality of gross error tests comprises (i) a nodal test, (ii) a measurement test and (iii) a generalized likelihood ratio test.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for data reconciliation using a robust estimator guided physics informed neural network, according to some embodiments of the present disclosure.

FIGS. 2A and 2B, with reference to FIG. 1, illustrates an exemplary flow diagram illustrating a method for data reconciliation using the robust estimator guided physics informed neural network, using the system of FIG. 1, in accordance with some embodiments of the present disclosure.

FIG. 3, with reference to FIG. 1, is a block diagram illustrating a functioning of a data reconciliation module for data reconciliation using the robust estimator guided physics informed neural network, in accordance with some embodiments of the present disclosure.

FIG. 4 is a flow diagram illustrating a first test case for data reconciliation using the robust estimator guided physics informed neural network, in accordance with some embodiments of the present disclosure.

FIG. 5 is a flow diagram illustrating a second test case for data reconciliation using the robust estimator guided physics informed neural network, in accordance with some embodiments of the present disclosure.

FIG. 6 is a flow diagram illustrating a third test case for data reconciliation using the robust estimator guided physics informed neural network, in accordance with some embodiments of the present disclosure.

FIGS. 7A, 7B, 7C depict graphical representations illustrating average mean square error (MSE) of each stream before and after data reconciliation for the first test case, the second test case and the third test case respectively, in accordance with some embodiments of the present disclosure.

FIGS. 8A, 8B, 8C depict graphical representations illustrating a comparison of the robust estimator guided physics informed neural network (PINN) and a robust estimator such as QWLS in terms of a relative error reduction (RER) metric for the first test case, the second test case and the third test case respectively, in accordance with some embodiments of the present disclosure.

FIGS. 9A, 9B, 9C, 9D, 9E, 9F depict graphical representations illustrating a comparison of material balance residuals in each unit before and after data reconciliation for the first test case, the second test case and the third test case respectively, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following embodiments described herein.

Manufacturing industries continuously monitor processes by measuring thousands of process variables and taking corrective actions to meet ever-evolving quality standards, safety regulations and environmental mandates. To make the best possible modifications in a process, its actual state must be known. This information is achieved through monitoring. These measurements of process variables are used for various activities such as optimization, process control, equipment maintenance or scheduling, management planning and decision making to run the process in an optimal and efficient manner. Since all these activities play a crucial role in attaining a final goal, it is important that the measurements received by all these tasks are accurate and reliable. Thus, there is need for a data reconciliation technique which can effectively rectify errors in the measurements, estimate unmeasured variables, detect and identify gross errors, thereby providing accurate and complete information about the state of the process.

The present disclosure addresses the unresolved problems of the conventional approaches by providing a system that integrates real-time, physics informed data reconciliation with adaptive system identification. The present disclosure utilizes a physics informed neural network architecture which easily incorporates physical laws and constraints of the process allowing the neural network to train only on raw measurements, thus eliminating the requirement of true values. Unlike existing solutions, which rely on manual system identification, the system of the present disclosure adapts to changing system network through its redundancy analysis and pretrained model identifier and performs reconciliation instantaneously. Thus, the present disclosure addresses all key aspects of the data reconciliation problem including rectification of random and gross errors in the measurements, providing data that satisfies physics of the process should function in real-time, and should adapt to changing process flow networks.

Embodiments of the present disclosure provide a system and method for data reconciliation using robust estimator guided physics informed neural network. The system of the present disclosure integrates a robust estimator such as Quasi-Weighted Least Squares (QWLS) estimator within a Physics Informed Neural Network (PINN) framework. Measurements of the processes are given as inputs to the physics informed neural network architecture and outputs are reconciled estimates. Instead of using regular loss criterion, a robust estimator equation such as QWLS, physics and constraints of the processes are formulated as loss functions in neural network architecture. While training, the physics informed neural network architecture tries to minimize its overall weighted loss function thereby minimizing an overall error while ensuring to satisfy underlying physics. Unlike conventional reconciliation methods (e.g., least squares estimation), robust estimators are insensitive to gross errors which is achieved by tuning an estimator parameter. This minimizes an influence of large biases on reconciled estimates. This is applicable to steady state linear as well as nonlinear systems. The physics informed neural network architecture can easily learn nonlinear functions eliminating the need for linear approximations. Due to the PINN framework, any arbitrary constraint can be easily incorporated as a loss function making it versatile and applicable to a wide range of industrial processes.

The present disclosure uses physics informed neural network architecture for real-time rectification of errors. Once the physics informed neural network architecture is trained, it provides instantaneous predictions allowing immediate reconciliation of incoming data. Real-time capability provides operators with timely insights, enabling prompt actions. Process equations such as mass balance, energy balance, species composition, kinetic equations, thermodynamic relationships, and/or the like, can be directly embedded as penalty terms in the loss function. By minimizing this loss function, the PINN learns a solution that not only fits the data but also ensures that the reconciled estimates are consistent with imposed governing laws and constraints. Due to incorporation of the physics, it does not require true values for training, unlike conventional neural network methods.

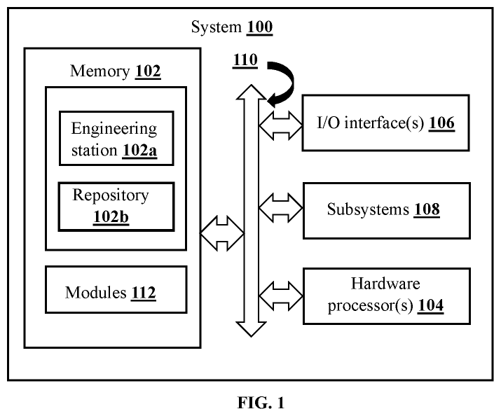

Referring now to the drawings, and more particularly to FIGS. 1 through 9F, where similar reference characters denote corresponding features consistently throughout the figures, there are shown preferred embodiments, and these embodiments are described in the context of the following exemplary system and/or method.

FIG. 1 illustrates an exemplary system 100 for data reconciliation using a robust estimator guided physics informed neural network, according to some embodiments of the present disclosure. The system 100 is comprised in a plant pertaining to a typical process and manufacturing industry. There are various processes occurring in various unit operations and unit processes in the plant. In an embodiment, the system 100 includes or is otherwise in communication with one or more hardware processors 104, communication interface device(s) or input/output (I/O) interface(s) 106, one or more subsystems 108, and one or more data storage devices or memory 102 operatively coupled to the one or more hardware processors 104. The one or more subsystems 108 may include one or more automation systems such as sensors, transmitters, data acquisition systems, and the like for continuous data collection from the plant. The one or more hardware processors 104, the memory 102, and the I/O interface(s) 106 may be coupled to a system bus 110 or a similar mechanism.

The I/O interface(s) 106 may include a variety of software and hardware interfaces, for example, a web interface, a graphical user interface, an operator user interface, and the like. The operator user interface is a centralized operating center where an operator observes operations of the plant, view process warnings and alarms, and monitors production. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. The one or more hardware processors 104 are configured to process data and are responsible for the data that moves between an operator level and one or more devices in the plant. In an embodiment, the system 100 can be implemented in a variety of computing systems, such as laptop computers, portable computer, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes an engineering station 102a comprising a plurality of modules 112 and a repository 102b for storing data processed, received, and generated by one or more of the plurality of modules 112. The plurality of modules 112 may include routines, programs, objects, components, data structures, and so on, which perform particular tasks or implement particular abstract data types so that the plant can operate at optimal conditions.

The plurality of modules 112 may include programs or computer-readable instructions or coded instructions that supplement applications or functions performed by the system 100. The plurality of modules 112 may also be used as signal processor(s), state machine(s), logic circuitries, and/or any other device or component that manipulates signals based on operational instructions. The plurality of modules 112 may comprise a data reconciliation module, a control system module, an optimization module, a simulation module, a prediction module, a gross error detection and identification module, an offline model development module, and the like. Further, the plurality of modules 112 can be used by hardware, by computer-readable instructions executed by the one or more hardware processors 104, or by a combination thereof. Further, the memory 102 may include information pertaining to input(s)/output(s) of each step performed by the processor(s) 104 of the system 100 and methods of the present disclosure.

The repository 102b may include an archive station or a data engine. Data from different sources such as online data from sensors in the plant, laboratory data, quality control, inspecting and testing data are collected and sent to the archive station. Further, the repository 102b amongst other things, may serve as a database or includes a plurality of databases for storing the data that is processed, received, or generated as a result of the execution of the plurality of modules 112. The plurality of databases may include a process database, process flow diagram (PFD) database, a model database, knowledge database, and the like. The process database may comprise real-time collected data from the plant, offline data and plant historical data. The process flow diagram (PFD) database may comprise a process model network providing insights on equipment in operation, shutdown, under maintenance, stream rerouting, and the like. The model database is a collection of all trained and deployed models under different measured variables and plant network. The knowledge database may comprise data about the physical and chemical properties of materials, values of different process parameters and coefficients. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

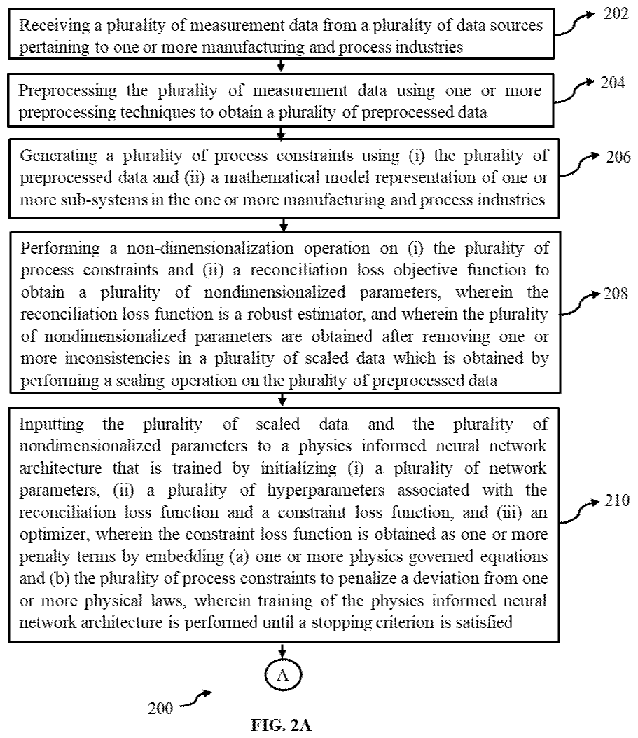

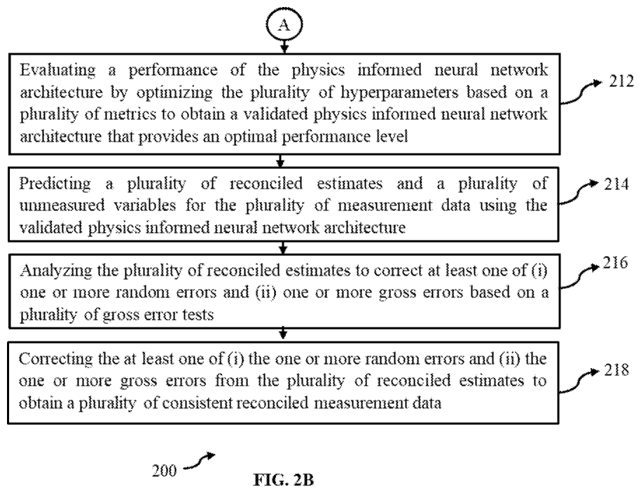

FIGS. 2A and 2B illustrate an exemplary flow diagram illustrating a method for data reconciliation using the robust estimator guided physics informed neural network, using the system 100 of FIG. 1, in accordance with some embodiments of the present disclosure.

Referring to FIG. 2A, in an embodiment, the system(s) 100 comprises one or more data storage devices or the memory 102 operatively coupled to the one or more hardware processors 104 and is configured to store instructions for execution of steps of the method by the one or more processors 104. The steps of the method 200 of the present disclosure will now be explained with reference to components of the system 100 of FIG. 1, the flow diagram as depicted in FIGS. 2A and 2B, and one or more examples. Although steps of the method 200 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

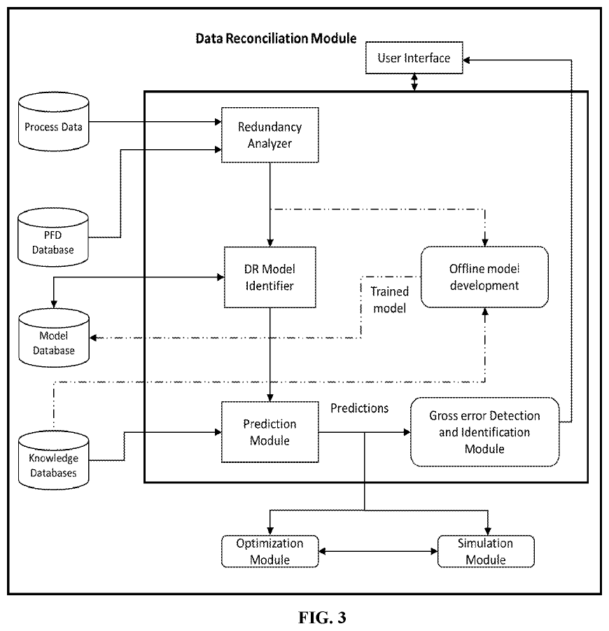

In an embodiment, at step 202 of the present disclosure, one or more hardware processors 104 are configured to receive a plurality of measurement data from a plurality of data sources pertaining to one or more manufacturing and process industries. The plurality of measurement data represents a plurality of raw data received from a plant associated with manufacturing and process industries which is received by a data reconciliation module. The plurality of data sources may include but are not limited to one or more sensors, one or more satellite based data sources, and/or the like. The plurality of measurement data may include but are not limited to real-time collected data from the plant such as flow rates, temperature, pressure, composition, level, measured in different units, equipment, and streams to determine the state of a process, online data from the one or more sensors in the plant, laboratory data, quality control, inspecting and testing data, offline data, plant historical data, and/or the like. FIG. 3 is a block diagram illustrating functioning of the data reconciliation module for data reconciliation using robust estimator guided physics informed neural network, in accordance with some embodiments of the present disclosure. As shown in FIG. 3, the first component in data reconciliation module is a redundancy analyzer. The plurality of measurement data (also referred as process data) along with a process model or process flow network from a process flow diagram (PFD) database is received in this step. This information is used to perform redundancy and observability analysis, where each variable is either measured or not measured. This step is required as some variables cannot be measured due to practical or economic limitations, so a minimum number of measurements should be made such that redundancy exists in the data. If there is no redundancy, then the variables cannot be adjusted.

The redundancy analyzer uses a variable classification algorithm which separates all the process variables into five types. These are redundant, non-redundant, observable, non-observable and specific candidates. Measured variables are classified into redundant and non-redundant whereas unmeasured variables are classified into observable, non-observable and specific candidates. Observable variables are the unmeasured variables which can be estimated by using the measured variables and a plurality of process constraints. A measured variable is said to be redundant when it is observable even after removing its measurement. Specific candidates are those variables whose values must be provided by an operator/user so that the system does not have any non-observable variables. Out of these five types of variables, only measured variables (redundant and non-redundant) and specific candidates are given as an input to next component, DR Model Identifier in an online application whereas for a new model development this information is sent to an Offline Model Development module. The variables which are redundant, non-redundant and specific candidates are sent to a Data Reconciliation (DR) Model identifier.

Further, at step 204 of the present disclosure, the one or more hardware processors 104 are configured to the plurality of measurement data using one or more preprocessing techniques to obtain a plurality of preprocessed data. The one or more preprocessing techniques may include but are not limited to data cleaning techniques, normalization techniques, and/or the like. A standard deviation is computed for each of the plurality of measurement data. The step of preprocessing helps in normalizing the plurality of measurement data using min-max scaling across different variables and their standard deviations.

Further, at step 206 of the present disclosure, the one or more hardware processors 104 are configured to generate a plurality of process constraints using (i) the plurality of preprocessed data and (ii) a mathematical model representation of one or more sub-systems in the one or more manufacturing and process industries. The process flow network is represented in the form of matrices depicting the connections between various units and streams in the plant. The rows and columns of the matrix represent the units and streams respectively. The values in the matrix can be either 1, −1, or 0 depending on whether the stream enters, leaves or has no association with the unit respectively. Using this matrix and information of properties, the plurality of process constraints are generated. The plurality of process constraints may include but are not limited to operational limits, safety requirements, physical bounds on variables, and one or more governing equations including total and component wise mass balances, energy conservation equations, constraints related to sum of species compositions in each stream, kinetic rate expressions, thermodynamic relationships, and/or the like.

Furthermore, at step 208 of the present disclosure, the one or more hardware processors 104 are configured to perform a non-dimensionalization operation on (i) the plurality of process constraints and (ii) a reconciliation loss objective function to obtain a plurality of nondimensionalized parameters. The plurality of nondimensionalized parameters are obtained after removing one or more inconsistencies in a plurality of scaled data which is obtained by performing a scaling operation on the plurality of preprocessed data. The reconciliation loss function is a robust estimator such as a Quasi Weighted Least Squares (QWLS) estimator. For data reconciliation application any reconciliation objective function must be used as one of the loss functions so that a network can learn how to reconcile the data. Robust estimator such as QWLS does not get affected by gross errors, so it is used as the reconciliation loss function. Along with the plurality of process constraints, the robust estimator is also non-dimensionalized. The non-dimensionalization operation is performed for (i) eliminating disparities between the plurality of scaled data, (ii) ensuring that a plurality of output variables vary within a predefined, and (iii) achieving a convergence.

At step 210 of the present disclosure, the one or more hardware processors 104 are configured to input the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer. The one or more hyperparameters may include but are not limited to learning rate, weights of the loss terms for loss balancing, number of points sampled for training, number of iterations, and/or the like. The constraint loss function is obtained as one or more penalty terms by embedding (a) one or more physics governed equations and (b) the plurality of process constraints to penalize a deviation from one or more physical laws.

The process flow network is fed as an input in the form of matrices depicting the connections between various units and streams in the plant. The physics informed neural network architecture is a multilayer perceptron network comprising (i) a plurality of layers, (ii) a plurality of neurons in each of the plurality of layers, and (iii) one or more activation functions tailored to a specific process and an associated process complexity. In an embodiment, input to the physics informed neural network architecture may include but are not limited to process data and standard deviation associated with the plurality of measurement data, process flow network and any physical and chemical properties such as densities, specific heat capacities, coefficients and constants, and/or the like. The physics informed neural network architecture chosen for this task is a fully connected neural network with the input layer having same number of neurons as sum of measured variables and specific candidates, output layer having neurons equal to a sum of variables to be reconciled and estimated. The physics informed neural network architecture should neither be too wide and deep which may lead to difficulties in optimizing nor be too shallow and narrow which may not capture complex relationships. The physics informed neural network architecture is flexible and not limited to a specific number of layers or configurations. The physics informed neural network architecture may employ a plurality of activation functions including but not limited to ReLU, tanh, softplus, sigmoid, and/or the like. The physics informed neural network architecture can be initialized using one or more techniques, including but not limited to Glorot initialization, He initialization, Xavier initialization, and/or the like. Then, the one or more hyper-parameters are selected. With defined network architecture, formulated loss functions, hyper-parameters and an optimizer including but not limited to Adam, Stochastic Gradient Descent (SGD), Limited-Memory Broyden-Fletcher-Goldfarb-Shanno (L-BFGS), Root Mean Squared Propagation (RMSprop), the physics informed neural network architecture is compiled and trained. These network parameters are chosen and adapted based on specific problem or application requirements.

In an embodiment, training of the physics informed neural network architecture is performed until a stopping criterion is satisfied. The stopping criterion states that the physics informed neural network architecture reaches a convergence value, which represents a threshold indicating that the difference between consecutive iterations of the integrated loss function fall below a predefined tolerance limit. This tolerance limit can be dynamically determined based on the problem characteristics or application requirements ensuring adaptability. The integrated loss function is formulated using a weighted sum of the reconciliation loss function and the constraint loss function. This integrated loss function is used for training the physics informed neural network architecture where reconciliation loss function represents a non-dimensionalized robust estimator such as QWLS equation and constraint loss function represents a set of equations comprising all the non-dimensionalized process constraints. The physics informed neural network architecture is trained until it converges and the difference between the loss functions of two consecutive iterations is below the predefined tolerance limit. In the context of the present disclosure, a value of the predefined tolerance limit obtained is 1e^{-0.6}.

Referring to FIG. 2B, at step 212 of the present disclosure, the one or more hardware processors 104 are configured to evaluate a performance of the physics informed neural network architecture by optimizing the plurality of hyperparameters based on a plurality of metrics to obtain a validated physics informed neural network architecture that provides an optimal performance level. After reaching convergence, the performance of the physics informed neural network architecture is evaluated based on a comparison with the robust estimator performance. The optimal performance level indicates that the performance should exceed or at least be equal to the robust estimator performance. If the optimal performance is achieved, the physics informed neural network architecture is saved to the model database ready to be deployed. However, if the optimal performance is not achieved, then the one or more hyperparameters are changed and the physics informed neural network architecture is retrained. The plurality of metrics used to monitor the performance of the physics informed neural network architecture may include but are not limited to coefficient of determination (R²), Relative Error Reduction (RER), Mass balance error around each unit, Mean Squared Error (MSE) of the variables, Overall Power, Average number of type 1 errors, and/or the like. After determining each of the metric, it is compared with the robust estimator such as QWLS. If the optimal performance is not obtained, then a new set of hyper-parameters are chosen. Based on convergence rate, the learning rate is adjusted. Increasing number of points sampled for training increases an ability of the physics informed neural network architecture to learn but also becomes computationally intensive. So, data sampling is carefully chosen such that there is a balance between the performance and the computation time. Depending upon the conservation residuals, weights of the loss terms are adjusted. More weight is given to the loss term which has larger residual and vice versa

At step 214 of the present disclosure, the one or more hardware processors 104 are configured to predict a plurality of reconciled estimates and a plurality of unmeasured variables for the plurality of measurement data using the validated physics informed neural network architecture. Further, at step 216 of the present disclosure, the one or more hardware processors 104 are configured to analyze the plurality of reconciled estimates to correct at least one of (i) one or more random errors and (ii) one or more gross errors based on a plurality of gross error tests. The plurality of gross error tests comprises (i) a nodal test, (ii) a measurement test and (iii) a generalized likelihood ratio test.

The steps 212 through 216 are further better understood by way of following exemplary explanation.
As shown in FIG. 3, based on a process flow network in operation and measured variables, the DR Model identifier looks up in a model database in the archive station and accesses a suitable pretrained model architecture and sends it to a prediction module. A model architecture received by the prediction module is a physics informed neural network architecture which uses the process data, their associated standard deviations, the process flow network and the information from the knowledge database to predict the reconciled estimates and also estimates the unmeasured variables. The predictions are then sent to a Gross Error Detection and Identification (GEDI) module to detect whether there are gross errors in the measured data and identify in which unit and stream the gross error is present. The coefficient of determination (R²) metric shows goodness of fit of the model predictions with the robust estimator estimates. The Mean Squared Error (MSE) metric is used to determine error reduction in predictions. RER (Relative Error reduction) is a metric which quantifies the error in the measurements that has been reduced. It is calculated using two quantities: Measurement Relative Error (MRE) which tells quantity of error in measurements and Reconciled Relative Error (RRE) which tells how much error exists in reconciled estimates. Conservation residuals are left-over errors of the mass balance equations, energy balance, species composition equations or any other constraints in the process. It is used to determine whether the predictions satisfy the underlying physics of the system. Overall power and Average Number of Type 1 errors (AVT) are used to evaluate accuracy of detection and identification of gross errors. Overall power is defined as a ratio of the number of gross errors correctly identified to the number of gross errors present in the plurality of measurement data. AVT is defined as a ratio of the number of gross errors wrongly identified to the number of simulation trials run.

In other words, from the prediction module, the plurality of reconciled estimates are sent to the GEDI module to diagnose for gross errors. Three different gross error tests are implemented in GEDI module namely the nodal test to identify at which unit/equipment the gross error is present, the measurement test to identify which measurement has gross error and the generalized likelihood ratio test to detect and identify any gross errors caused due to process leaks or systematic biases. All the three tests use statistical techniques to detect gross errors. Two hypotheses are tested: null hypothesis where no gross is present and alternative hypothesis in which one or more gross errors are present. To accept or reject these hypotheses, a test statistic is used which can be a function of adjustment in measurements, constraint residuals, process model depending on the type of test. The test statistic is compared with a specified critical value with one or more defined confidence limits. If it exceeds the critical value, then null hypothesis is rejected and vice versa. The test statistic for the nodal test is a function of constraint residual, measurement test is a function of the measurement adjustments, and the generalized likelihood ratio test is derived using the maximum likelihood ratio principle and it is a function of the measurements and process model. Each test gives an output of its recommendation of gross errors, and all these are consolidated and sent to the Operator user interface.

At step 218 of the present disclosure, the one or more hardware processors 104 are configured to correct the at least one of (i) the one or more random errors and (ii) the one or more gross errors from the plurality of reconciled estimates to obtain a plurality of consistent reconciled measurement data. From the GEDI module, the information about these errors is sent to the Operator User Interface which shows location of the error and helps the operators in taking necessary action.

After removing random and gross errors from the plurality of measurements, detecting and identifying any process leaks, equipment malfunction, and mis-calibrated devices, the plurality of consistent reconciled measurement data is obtained which is reliable. The plurality of consistent reconciled measurement data is then used for other purposes such as optimization, simulation, equipment maintenance, design, production planning, and/or the like. The error-free data is then received by a Simulation module where one or more users explore the behavior of the system 100 under various conditions. The optimization module uses the plurality of consistent reconciled measurement data and the data generated by simulations to refine these processes for better performance. Various objective functions are defined based on the goals the like with applicable constraints, where goals could be cost reduction, increased yield, minimizing emissions, improved product quality, and/or. Any efficient optimization technique is applied to find an optimal operating process conditions and parameters. Once the optimum operating process conditions are determined, they can be simulated again to ensure that the optimal performance is obtained. Often simulation and optimization modules work in an iterative way to determine the best optimal operating process conditions. The best optimal operating process conditions are treated as set points and sent to the control system module to regulate the system 100 through controllers and actuators for a desired outcome. The offline model development module is integrated so that the physics informed neural network architecture can be updated periodically from time to time so that the physics informed neural network architecture is adaptable to new process networks and new data. The input to this module is the process data, flow network and information from the Knowledge database.

### Experimental Results

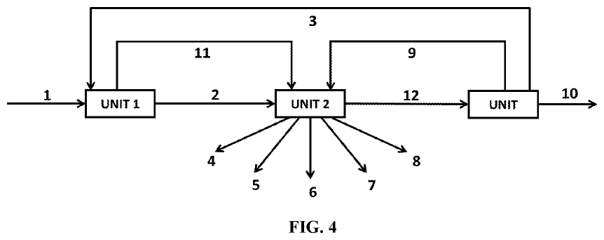

The present disclosure describes a plurality of test cases as a result of experimentation. FIG. 4 is a flow diagram illustrating a first test case for data reconciliation using the robust estimator guided physics informed neural network, in accordance with some embodiments of the present disclosure. The first test case is an exemplary atmospheric tower process. As shown in FIG. 4, an exemplary industrial atmospheric distillation tower containing 3 units and 12 streams is provided. The unit 1 in FIG. 4 represents a flash distillation tower, unit 2 represents an atmospheric distillation tower, and unit 3 represents a reflux tank of atmospheric tower. The streams in the flowsheet represent crude feed, bottom draw of flash distillation tower, top reflux of flash distillation tower, first side draw of atmospheric distillation tower, second side draw of atmospheric distillation tower, third side draw of atmospheric distillation tower, over-boiled of atmospheric distillation tower, bottom draw of atmospheric distillation tower, top reflux of atmospheric distillation tower, top product of atmospheric distillation tower, top draw of flash distillation tower, and top draw of atmospheric distillation tower respectively. Further, measurements of total flow rates and their associated standard deviations are received along with process flow diagram and reconciliation is carried out. Table 1 provides a comparison of R² values for each stream from the PINN architecture predictions and estimates of the robust estimator such as OWLS with respect to true values for the atmospheric tower process.

TABLE 1

| | | R² |
|---|---|---|
| | R² | (Robust |
| Stream | (PINN) | estimator) |
| 1 | 0.9958 | 0.9956 |
| 2 | 0.9957 | 0.9955 |
| 3 | 0.985 | 0.9844 |
| 4 | 0.9856 | 0.9851 |
| 5 | 0.9819 | 0.9816 |
| 6 | 0.9819 | 0.9818 |
| 7 | 0.9833 | 0.9839 |
| 8 | 0.9962 | 0.9961 |
| 9 | 0.983 | 0.9826 |
| 10 | 0.9824 | 0.9819 |
| 11 | 0.9836 | 0.9843 |
| 12 | 0.9859 | 0.9864 |

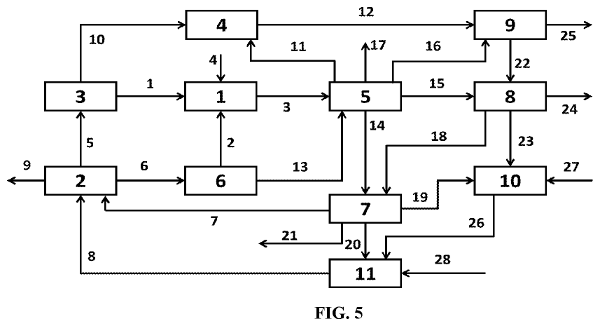

FIG. 5 is a flow diagram illustrating a second test case for data reconciliation using the robust estimator guided physics informed neural network, in accordance with some embodiments of the present disclosure. The second test case is an exemplary steam metering system. As shown in FIG. 5, an exemplary steam metering system for a methanol synthesis unit of a large chemical plant is provided. The steam metering system consists of 11 nodes/units and 28 streams. Wherever necessary, the individual streams have been aggregated for the sake of clarity, so that multiple streams are connected by a single stream to each unit. The actual steam flowrates are obtained by time-averaging over an 8-hour window and represent actual operating data. Further, measurements of total flow rates and their associated standard deviations along with process flow diagram are received and reconciliation is carried out.

Table 2 provides a comparison of R² values for each stream from the PINN architecture predictions and estimates of the robust estimator such as QWLS with respect to the true values for the steam metering system.

TABLE 2

| | | R² |
|---|---|---|
| | R² | (Robust |
| Stream | (PINN) | estimator) |
| 1 | 0.9111 | 0.9154 |
| 2 | 0.9122 | 0.911 |
| 3 | 0.9924 | 0.9924 |
| 4 | 0.9924 | 0.9923 |
| 5 | 0.9727 | 0.9735 |
| 6 | 0.992 | 0.9922 |
| 7 | 0.9164 | 0.9154 |
| 8 | 0.991 | 0.9912 |
| 9 | 0.9181 | 0.919 |
| 10 | 0.9724 | 0.9735 |
| 11 | 0.9229 | 0.9214 |
| 12 | 0.9725 | 0.973 |
| 13 | 0.9919 | 0.9922 |
| 14 | 0.9111 | 0.968 |
| 15 | 0.968 | 0.9548 |
| 16 | 0.9526 | 0.921 |
| 17 | 0.9247 | 0.9198 |
| 18 | 0.9183 | 0.919 |
| 19 | 0.9153 | 0.9189 |
| 20 | 0.9203 | 0.9212 |
| 21 | 0.919 | 0.9699 |
| 22 | 0.9695 | 0.9132 |
| 23 | 0.9188 | 0.9178 |
| 24 | 0.9166 | 0.9511 |
| 25 | 0.9484 | 0.9705 |
| 26 | 0.97 | 0.973 |
| 27 | 0.9734 | 0.9733 |
| 28 | 0.9735 | 0.9927 |
| — | — | |
| — | — | |

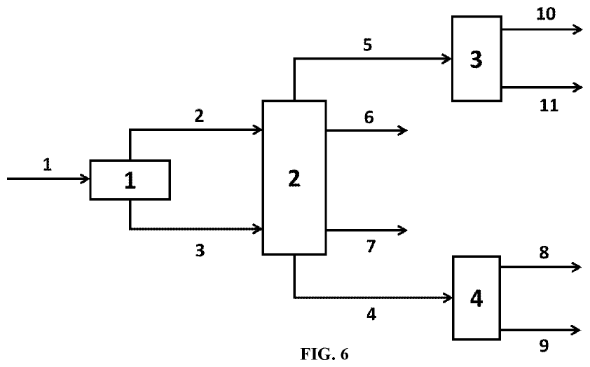

FIG. 6 is a flow diagram illustrating a third test case for data reconciliation using the robust estimator guided physics informed neural network, in accordance with some embodiments of the present disclosure. The third test case is an exemplary synthetic juice extraction unit. The process consists of a beverage alcohol distillation plant continuously fed by a fermentation unit. As shown in FIG. 6, an incoming feed to a splitter (unit 1) is split and fed to a distillation column (unit 2). Top and bottom products from unit 2 are again sent for distillation to units 3 and 4. Multiple distillation columns are used to get high purity components. Further, the measurements of total flow rates and their associated standard deviations along with process flow diagram are received and reconciliation is carried out. Table 3 provides a comparison of R² values for each stream from the PINN architecture predictions and estimates of the robust estimator such as QWLS with respect to the true values for the synthetic juice extraction unit.

TABLE 3

| | | R² |
|---|---|---|
| | R² | (Robust |
| Stream | (PINN) | estimator) |
| 1 | 0.9681 | 0.9689 |
| 2 | 0.9769 | 0.9767 |
| 3 | 0.9153 | 0.9125 |
| 4 | 0.965 | 0.9666 |
| 5 | 0.9377 | 0.9379 |
| 6 | 0.8736 | 0.8722 |
| 7 | 0.8895 | 0.8878 |
| 8 | 0.9321 | 0.9324 |
| 9 | 0.9648 | 0.9665 |
| 10 | 0.8848 | 0.8856 |
| 11 | 0.9377 | 0.9374 |
| — | — | |

It is analyzed from Tables 1, 2 and 3 that high R² (i.e., greater than 0.9) values shows that the PINN model predictions are close to the true values for all the test cases. Uniformity of the R² values across different streams shows that the PINN model performs consistently well for all streams irrespective of the wide variation in their order of magnitudes. Comparing with the R² values obtained from robust estimator estimates shows the PINN model performs similarly as a robust estimator but in real-time without any iterative steps. Very few streams have an R² value less than 0.9, but it is at par with the performance of robust estimator such as QWLS. For each of the plurality of test cases, performance obtained is at least same as robust estimator indicating that the PINN model generalizes well as the plurality of test cases have different complexities in terms of their topographical structure and magnitude of flow rates.

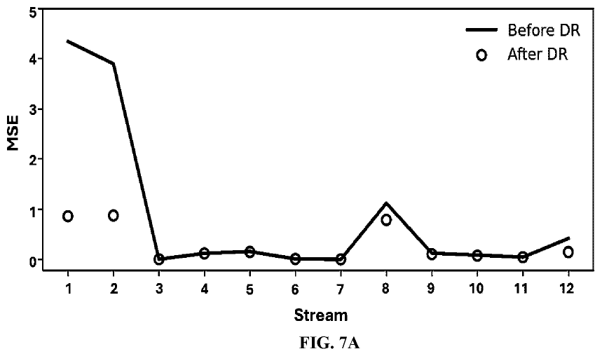

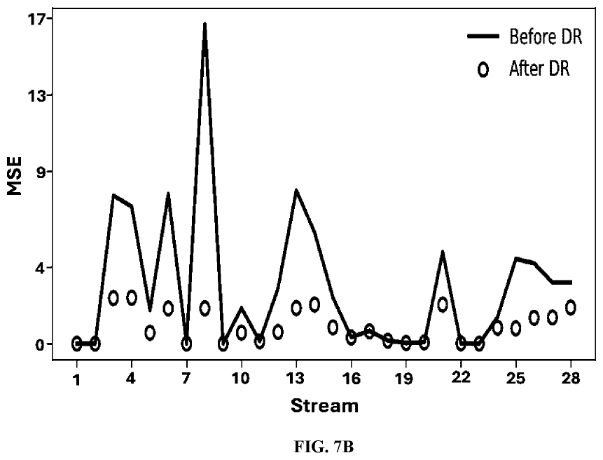

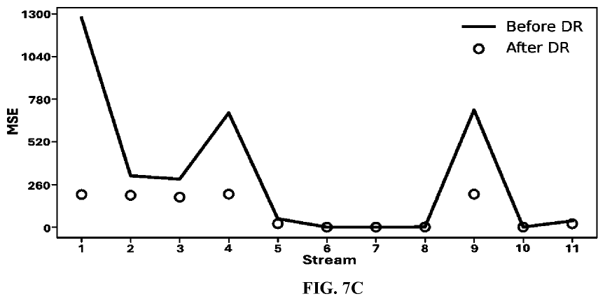

FIGS. 7A through 7C depict graphical representations illustrating average mean square error (MSE) of each stream before and after data reconciliation for the first test case, the second test case and the third test case respectively, in accordance with some embodiments of the present disclosure. MSE metric was used to analyze the PINN model's capability in rectifying random errors. MSE plots show an average error of each stream flowrate with respect to their true values, for both raw measurements and predicted reconciled estimates. The MSE values of the raw measurements are plotted as a solid line and MSE values of the PINN predictions are plotted as circles. The PINN model significantly reduced the MSE of the streams for all the test cases, especially for the test case of Synthetic juice extraction unit, where the MSE before reconciliation was very high. This demonstrates that the model can correct substantial deviations from true values. For the streams with lower MSE in the raw measurements, a scope for improvement was close to zero, hence the MSE is similar for the PINN model predictions after reconciling which shows that the PINN model is capable in rectifying random errors across all streams.

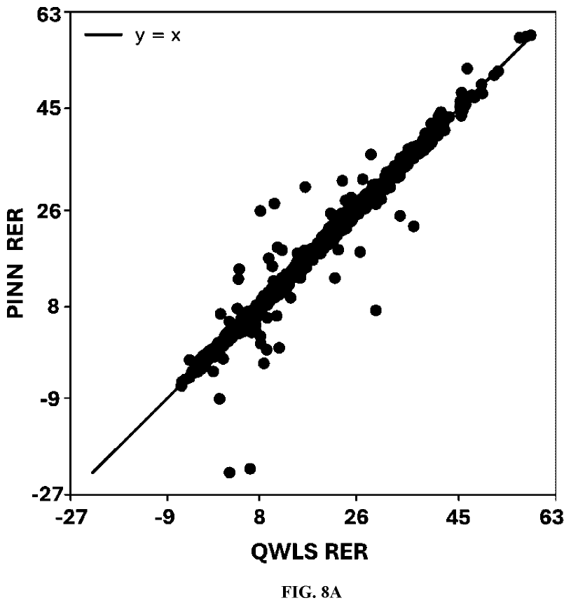

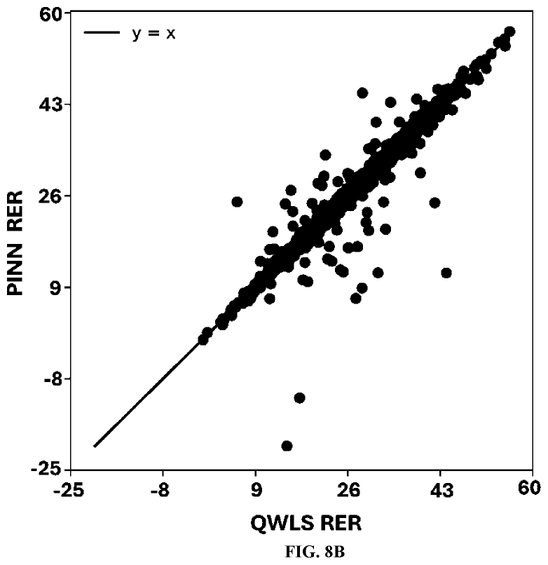

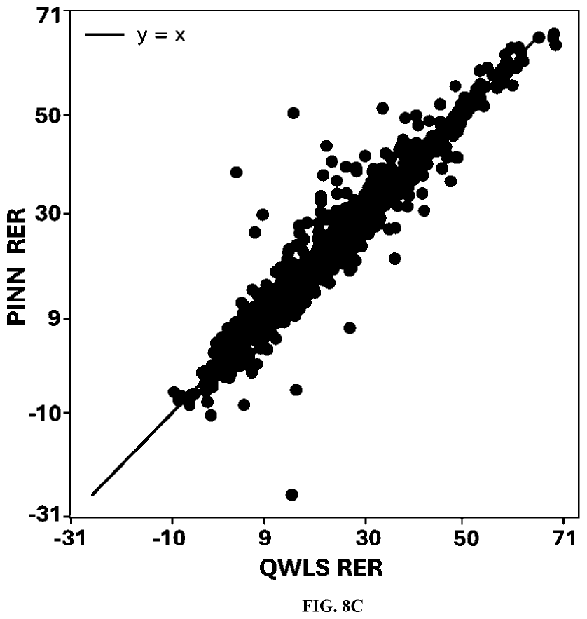

FIGS. 8A through 8C depict graphical representations illustrating a comparison of the physics informed neural network (PINN) and a robust estimator such as QWLS in terms of a relative error reduction (RER) metric for the first test case, the second test case and the third test case respectively, in accordance with some embodiments of the present disclosure. RER is a metric which simultaneously quantifies how much error has been corrected from the measurements and how much the reconciled estimates deviate from the true values. For a good reconciliation method, a large Relative Error Reduction (RER) is expected. RER obtained from the PINN model predictions is compared against the RER calculated from robust estimator estimates. Since the robust estimator such as QWLS estimator is used as a loss function in the PINN formulation, ideally the predictions should approximate the results of the robust estimator. For all the test cases, majority of data points lie close to y=x line, indicating the PINN model mimics the robust estimator estimates fairly well, with an exception of a few outliers.

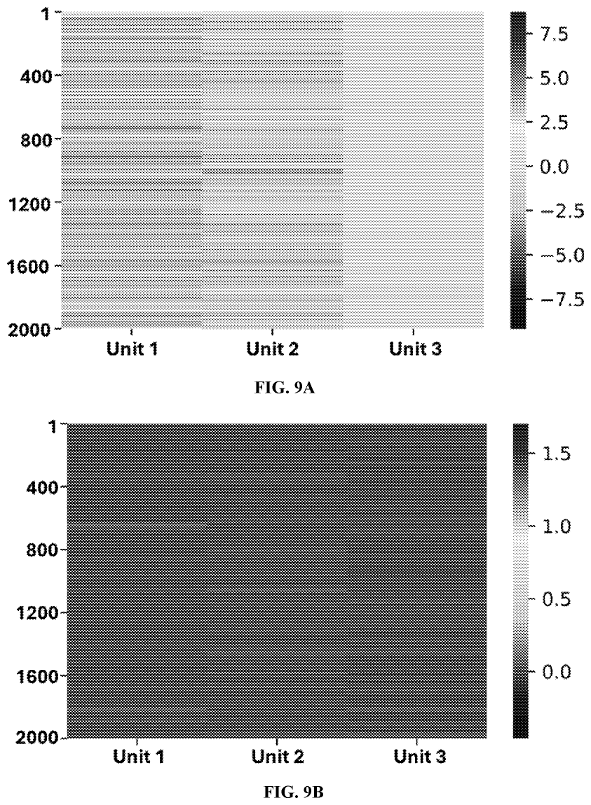

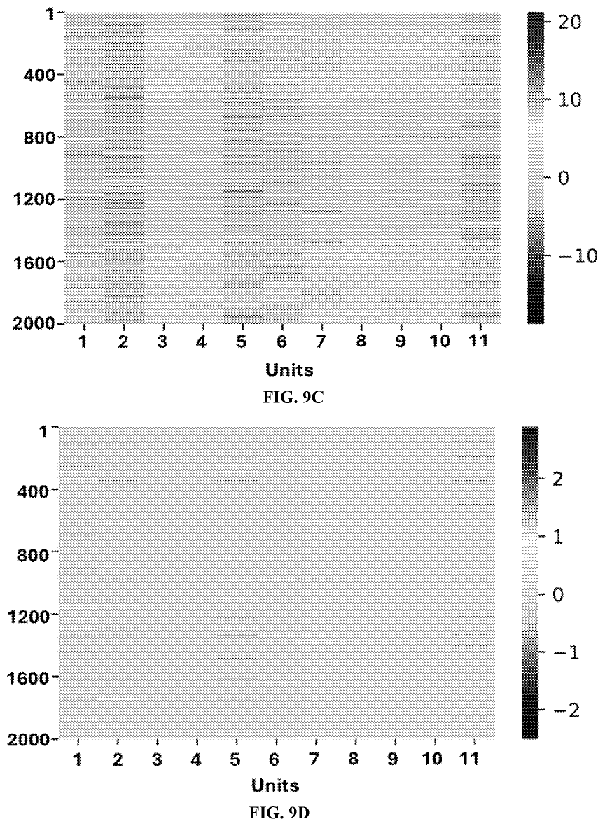

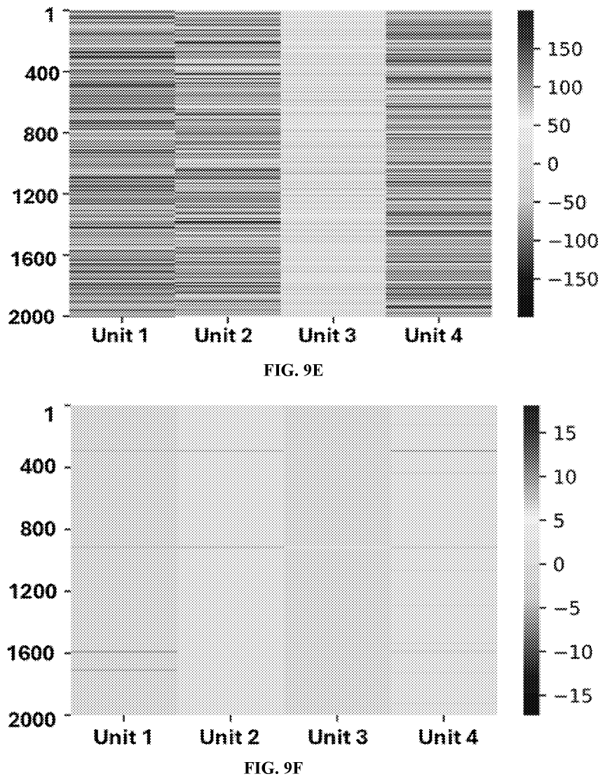

FIGS. 9A through 9F depict graphical representations illustrating a comparison of material balance residuals in each unit before and after data reconciliation for the first test case, the second test case and the third test case respectively, in accordance with some embodiments of the present disclosure. FIGS. 9A and 9B depict graphical representations illustrating a comparison of material balance residuals in each unit before and after data reconciliation for the first test case, in accordance with some embodiments of the present disclosure. FIGS. 9C and 9D depict graphical representations illustrating a comparison of material balance residuals in each unit before and after data reconciliation for the second test case, in accordance with some embodiments of the present disclosure. FIGS. 9E and 9F depict graphical representations illustrating a comparison of material balance residuals in each unit before and after data reconciliation for the third test case, in accordance with some embodiments of the present disclosure.

Important aspect of data reconciliation is that the reconciled estimates should be consistent with underlying physics of the process. To analyze this, a heatmap of mass balance residuals are plotted for each unit for the measurements contaminated with random error and the reconciled estimates predicted by PINN model. The columns in the heat map depict a mass balance error around the units in the process. The rows depict number of observations evaluated to check conservation of mass. For each observation, a magnitude of a mass balance residual is depicted by a line in the bar scale. The heatmap visually illustrate an effectiveness of the PINN model in reducing discrepancies. The darker lines and non-uniform distribution in the FIGS. 9A, 9C, 9E depict a presence of significant residuals in the measurements before reconciliation. However, there is a marked reduction in the mass balance residuals for the PINN predictions across all units after reconciliation. The predominant lighter lines and a uniform distribution in the FIGS. 9B, 9D, 9F indicate that the PINN model has not only corrected random errors but also provided consistent data which aligns well with the plurality of process constraints. For the first test case, the heatmap after reconciliation shown in FIGS. 9B, has darker lines but the magnitude of the errors has been reduced as shown by the bar scale of the heatmap when compared with the bar scale of the FIG. 9A.

The written description describes the subject matter herein to enable any person skilled in the art to make and use the embodiments. The scope of the subject matter embodiments is defined herein and may include other modifications that occur to those skilled in the art. Such other modifications are intended to be within the scope of the present disclosure if they have similar elements that do not differ from the literal language of the embodiments or if they include equivalent elements with insubstantial differences from the literal language of the embodiments described herein.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated herein by the following claims.

We claim:

1. A processor implemented method, comprising:
receiving, via one or more hardware processors, a plurality of measurement data from a plurality of data sources pertaining to one or more manufacturing and process industries;
preprocessing, via the one or more hardware processors, the plurality of measurement data using one or more preprocessing techniques to obtain a plurality of preprocessed data;
generating, via the one or more hardware processors, a plurality of process constraints using (i) the plurality of preprocessed data and (ii) a mathematical model representation of one or more sub-systems in the one or more manufacturing and process industries;
performing, via the one or more hardware processors, a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data;
inputting, via the one or more hardware processors, the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied;
evaluating, via the one or more hardware processors, a performance of the physics informed neural network architecture by optimizing the plurality of hyperparameters based on a plurality of metrics to obtain a validated physics informed neural network architecture that provides an optimal performance level;
predicting, via the one or more hardware processors, a plurality of reconciled estimates and a plurality of unmeasured variables for the plurality of measurement data using the validated physics informed neural network architecture;
analyzing, via the one or more hardware processors, the plurality of reconciled estimates to correct at least one of (i) one or more random errors and (ii) one or more gross errors based on a plurality of gross error tests; and
correcting, via the one or more hardware processors, the at least one of (i) the one or more random errors and (ii) the one or more gross errors from the plurality of reconciled estimates to obtain a plurality of consistent reconciled measurement data.

2. The processor implemented method of claim 1, wherein the physics informed neural network architecture is a multilayer perceptron network comprising (i) a plurality of layers, (ii) a plurality of neurons in each of the plurality of layers, and (iii) one or more activation functions tailored to a specific process and an associated process complexity.

3. The processor implemented method of claim 1, wherein the non-dimensionalization operation is performed for (i) eliminating one or more disparities between the plurality of scaled data, (ii) ensuring that a plurality of output variables vary within a predefined range, and (iii) achieving a convergence.

4. The processor implemented method of claim 1, wherein the stopping criterion states that the physics informed neural network architecture reaches a convergence value which represents that a difference between consecutive iterations of an integrated loss function falls below a predefined tolerance limit, where the integrated loss function is formulated using a weighted sum of the reconciliation loss function and the constraint loss function.

5. The processor implemented method of claim 1, wherein the plurality of gross error tests comprises (i) a nodal test, (ii) a measurement test and (iii) a generalized likelihood ratio test.

6. A system, comprising:
a memory storing instructions;
one or more communication interfaces;
one or more subsystems; and
one or more hardware processors coupled to the memory via the one or more communication interfaces, wherein the one or more hardware processors are configured by the instructions to:
receive a plurality of measurement data from a plurality of data sources pertaining to one or more manufacturing and process industries;
preprocess the plurality of measurement data using one or more preprocessing techniques to obtain a plurality of preprocessed data;
generate a plurality of process constraints using (i) the plurality of preprocessed data and (ii) a mathematical model representation of one or more sub-systems in the one or more manufacturing and process industries;
perform a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data;
input the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied;
evaluate a performance of the physics informed neural network architecture by optimizing the plurality of hyperparameters based on a plurality of metrics to obtain a validated physics informed neural network architecture that provides an optimal performance level;
predict a plurality of reconciled estimates and a plurality of unmeasured variables for the plurality of measurement data using the validated physics informed neural network architecture; and
analyze the plurality of reconciled estimates to correct at least one of (i) one or more random errors and (ii) one or more gross errors based on a plurality of gross error tests; and
correct the at least one of (i) the one or more random errors and (ii) the one or more gross errors from the plurality of reconciled estimates to obtain a plurality of consistent reconciled measurement data.

7. The system of claim 6, wherein the physics informed neural network architecture is a multilayer perceptron network comprising (i) a plurality of layers, (ii) a plurality of neurons in each of the plurality of layers, and (iii) one or more activation functions tailored to a specific process and an associated process complexity.

8. The system of claim 6, wherein the non-dimensionalization operation is performed for (i) eliminating one or more disparities between the plurality of scaled data, (ii) ensuring that a plurality of output variables vary within a predefined range, and (iii) achieving a convergence.

9. The system of claim 6, wherein the stopping criterion states that the physics informed neural network architecture reaches a convergence value and which represents that a difference between consecutive iterations of an integrated loss function falls below a predefined tolerance limit, where the integrated loss function is formulated using a weighted sum of the reconciliation loss function and the constraint loss function.

10. The system of claim 6, wherein the plurality of gross error tests comprises (i) a nodal test, (ii) a measurement test and (iii) a generalized likelihood ratio test.

11. One or more non-transitory machine-readable information storage mediums comprising one or more instructions which when executed by one or more hardware processors cause:
receiving a plurality of measurement data from a plurality of data sources pertaining to one or more manufacturing and process industries;
preprocessing the plurality of measurement data using one or more preprocessing techniques to obtain a plurality of preprocessed data;
generating a plurality of process constraints using (i) the plurality of preprocessed data and (ii) a mathematical model representation of one or more sub-systems in the one or more manufacturing and process industries;
performing a non-dimensionalization operation on (i) the plurality of process constraints and (ii) a reconciliation loss objective function to obtain a plurality of nondimensionalized parameters, wherein the reconciliation loss function is a robust estimator, and wherein the plurality of nondimensionalized parameters are obtained after removing one or more inconsistencies in a plurality of scaled data which is obtained by performing a scaling operation on the plurality of preprocessed data;
inputting the plurality of scaled data and the plurality of nondimensionalized parameters to a physics informed neural network architecture that is trained by initializing (i) a plurality of network parameters, (ii) a plurality of hyperparameters associated with the reconciliation loss function and a constraint loss function, and (iii) an optimizer, wherein the constraint loss function is obtained as one or more penalty terms by embedding (a) one or more physics governed equations and (b) the plurality of process constraints to penalize a deviation from one or more physical laws, wherein training of the physics informed neural network architecture is performed until a stopping criterion is satisfied;
evaluating a performance of the physics informed neural network architecture by optimizing the plurality of hyperparameters based on a plurality of metrics to obtain a validated physics informed neural network architecture that provides an optimal performance level;
predicting a plurality of reconciled estimates and a plurality of unmeasured variables for the plurality of measurement data using the validated physics informed neural network architecture;
analyzing the plurality of reconciled estimates to correct at least one of (i) one or more random errors and (ii) one or more gross errors based on a plurality of gross error tests; and
correcting the at least one of (i) the one or more random errors and (ii) the one or more gross errors from the plurality of reconciled estimates to obtain a plurality of consistent reconciled measurement data.

12. The one or more non-transitory machine-readable information storage mediums of claim 11, wherein the physics informed neural network architecture is a multilayer perceptron network comprising (i) a plurality of layers, (ii) a plurality of neurons in each of the plurality of layers, and (iii) one or more activation functions tailored to a specific process and an associated process complexity.

13. The one or more non-transitory machine-readable information storage mediums of claim 11, wherein the non-dimensionalization operation is performed for (i) eliminating one or more disparities between the plurality of scaled data, (ii) ensuring that a plurality of output variables vary within a predefined range, and (iii) achieving a convergence.

14. The one or more non-transitory machine-readable information storage mediums of claim 11, wherein the stopping criterion states that the physics informed neural network architecture reaches a convergence value which represents that a difference between consecutive iterations of an integrated loss function falls below a predefined tolerance limit, where the integrated loss function is formulated using a weighted sum of the reconciliation loss function and the constraint loss function.

15. The one or more non-transitory machine-readable information storage mediums of claim 11, wherein the plurality of gross error tests comprises (i) a nodal test, (ii) a measurement test and (iii) a generalized likelihood ratio test.
